(19) United States
(12) Patent Application Publication
(10) Pub. No.: US 2009/0090800 A1
(43) Pub. Date: Apr. 9, 2009

(54) METHOD AND APPARATUS FOR SHAPED OPENINGS IN A GRINDER SCREEN

(75) Inventor: Scott Rempe, Pella, IA (US)

Correspondence Address: MERCHANT & GOULD PC, P.O. BOX 2903, MINNEAPOLIS, MN, 55402-0903, US

(73) Assignee: Vermeer Manufacturing Company, Pella, IA (US)

(21) Appl. No.: 12/245,417

(22) Filed: Oct. 3, 2008

Related U.S. Application Data
(60) Provisional application No. 60/997,896, filed on Oct. 5, 2007.

(51) Int. Cl. B02C 13/284; B02C 13/286

(52) U.S. Cl. 241/88; 241/86

(57) ABSTRACT

A shaped opening is provided in the screen apparatus of a grinder. The shaped opening helps accumulate, gather and congregate materials that have not been reduced sufficiently in size. The shaped opening is located on the trailing edge of the screen opening. By being located on the trailing edge, lodged materials are urged into the shaped area during the grinding function. As more lodged materials are urged into the shaped area, the materials are congregated sufficiently for the cutters to engage the material and pull it back into the grinding chamber (and out of the screen).

### CROSS REFERENCE TO RELATED APPLICATIONS

This application claims the benefit of U.S. Provisional Application No. 60/997,896 filed Oct. 5, 2007. Such provisional application is incorporated herein by reference.

### TECHNICAL FIELD

The present disclosure relates generally to machines that grind, shred, and/or chip various types of material. More particularly, this disclosure relates to shaping the openings in a grinder screen. More particularly still, the disclosure relates to shaping grinder screen openings to create an area where material, which has not been ground sufficiently, is gathered for urging back into the grinder area.

### BACKGROUND

Machines, such as grinders and chippers, are used for shredding, grinding, and/or chipping a variety of materials. For example, such materials can include stalks, hay, straw, and other crop materials, wood, and construction debris. For the purposes of this disclosure, the preferred environment in which the principles of the invention are described will be that of a grinder. Horizontal grinders and tub grinders are illustrative of such machines, and the example of a horizontal grinder will be used herein as a preferred environment in which the present invention may be employed. References herein to horizontal grinders and tub grinders, however, are not intended to be limiting. Instead, the principles of the invention are generally applicable to machines which utilize a screen in connection with reducing larger materials into smaller materials.

Grinders and chippers include a chamber that houses a grinding or chipping unit (referred to collectively as a grinding unit for convenience). The grinding unit typically includes a grinding drum, which is rotated and includes hammers or blocks, and screens that position material so that it is forced into contact with the grinding drum until ground/reduced to a certain size. Once the materials are reduced to a size at or below the certain size, the materials pass through holes in the screen and exit out of the grinding chamber.

In some instances, the materials are not cut to a sufficiently small size. In these cases, particularly if the materials are stringy, the materials may lodge, wrap and/or otherwise be retained within the screen openings without being further reduced. In severe cases, the material can become trapped between the grinding drum and the screens thereby increasing the risk of plugging. Accordingly, there is a need in the art for a screen which gathers or congregates the materials in a manner which allows it to be returned into the cutting chamber for further reduction in size.

### SUMMARY

The present invention provides for at least one shaped opening in the screen that helps accumulate, gather and/or congregate materials that have not been reduced sufficiently in size. As noted, when stringy materials are not sufficiently reduced, the materials can lodge, wrap, or otherwise be retained within the openings in the screen (hereinafter referred to as “lodged” materials for convenience). The present invention provides a shaped area located in the trailing edge of the screen opening. By being located on the trailing edge, any lodged materials are urged into the shaped area during the grinding function. As more lodged materials are urged into the shaped area, the materials are congregated sufficiently for the cutters to engage the material and pull it back into the grinding chamber (and out of the screen).

Therefore, according to one aspect of the invention, there is provided a screen apparatus for a grinder comprising: a sheet of material formed about the periphery of a grinding drum having cutters arranged on the periphery, the grinding drum rotating about an axis of rotation; and an opening defined by and formed in the sheet of material, the opening including: a first portion sized and configured to allow ground material to pass therethrough; a trailing edge; and a second portion connected to the first portion along the trailing edge, wherein the second portion is arranged and configured to congregate material and urge the material back into the first portion.

While the invention will be described with respect to preferred embodiment configurations and with respect to particular devices used therein, it will be understood that the invention is not to be construed as limited in any manner by either such configuration or components described herein. While the example of a horizontal grinder is provided herein, the principles of this invention extend to any environment in which a drum and screen is used for cutting, chipping or grinding. These and other variations of the invention will become apparent to those skilled in the art upon a more detailed description of the invention.

The advantages and features which characterize the invention are pointed out with particularity in the claims annexed hereto and forming a part hereof. For a better understanding of the invention, however, reference should be had to the drawings which form a part hereof and to the accompanying descriptive matter, in which there is illustrated and described a preferred embodiment of the invention.

### BRIEF DESCRIPTION OF THE DRAWINGS

FIG. 1 is an exemplary horizontal grinder in which the principles of the present invention may be employed, with portions shown in partial sectional view;

FIG. 2 is a schematic view of a representative opening in the screen showing the first and second portions of the opening;

FIGS. 3a-3d schematically illustrate the congregation of lodged material and the engagement with the cutters;

FIGS. 4a-4b schematically illustrate first and second embodiments of the drum and screen rolled out flat; and

FIG. 5 illustrates an alternative embodiment of the shaped area.

### DETAILED DESCRIPTION

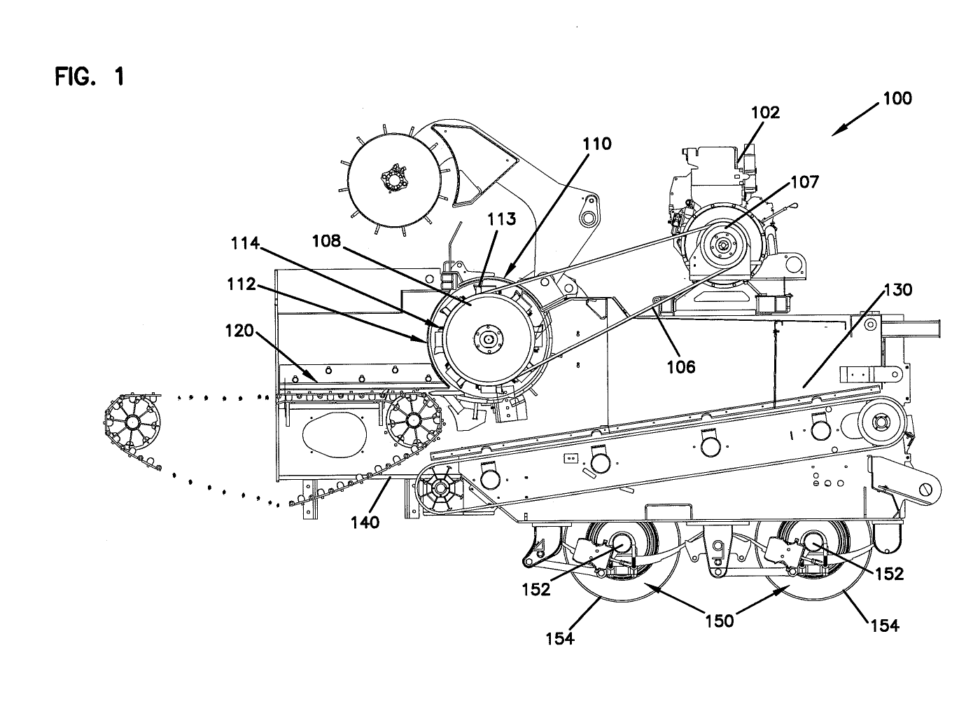

Referring now to the drawings wherein like reference numerals designate identical or corresponding parts throughout the several views, a horizontal grinder 100 is illustrated in FIG. 1. The horizontal grinder 100 illustrated in this embodiment includes a grinding unit 110, feed system 120 and discharge conveyor 130 mounted onto a frame 140 that is supported by ground support 150.

Many horizontal grinders are configured for mobile applications where the grinder is moved from one processing location to another. In the mobile configuration, the ground support 150 typically includes an axle 152 and wheels 154. Track units (i.e., either freely rotating tracks or powered tracks) may be used in lieu of wheels in some models of horizontal grinders. In other configurations the machines are set-up for stationary applications, such as for use in a paper mill or land-fill, where the material can be delivered to the machine. In this configuration the wheels may be omitted, with the frame fixedly secured to a foundation. The ground support is not an element of the current invention.

The frame 140 is supported by a ground support apparatus and includes side rails, and can also include a hitch point. The hitch point is adapted to cooperate with a towing vehicle, and may come any a variety of configurations. Typically the opposite end of the frame 140 is adapted to support discharge conveyor 130.

Discharge conveyor 130 is adapted to accept ground material from the grinding unit 110 and transport it to a location as desired by the operator. This may include transportation to a further processing machine such as a trommel screen, to a truck for transport, or to simply elevate the material to be dropped in order to create a pile.

The prime mover 102 is preferably mounted to the frame 140 and for mobile applications, preferably includes a diesel engine. Alternatively, the prime mover may be an electric motor. In either case the prime mover 102 provides power to the grinding unit 110, the feed system 120, and the discharge conveyor 130. The prime mover 102 provides power to the grinding unit 110 with drive belt 106 which is routed over drive pulley 107 and driven pulley 108. In one embodiment, the prime mover 102 also provides power to hydraulic pump (not shown), which is capable of generating fluid power. The fluid power is transferred to a hydraulic motor(s) (not shown) to power the feed conveyor 120 and the discharge conveyor 130. In stationary configurations, or those where electric power is readily available, the hydraulic motors can be replaced with electric motors.

The grinding unit 110 generally includes a grinding drum 114 and screens 112. An example of such a grinding drum can be found in U.S. Pat. Nos. 6,422,495 and 7,077,345 which are incorporated herein by reference. Other types of grinding members, rotors, plates, discs or other structures can also be used. The screens 112 are available in a variety of sizes and configurations, selected by the operator to achieve a desired size and quality of ground material. The selection of the screens will affect the performance of the machine 100. The configuration of the grinding drum 114 will likewise affect the performance of the machine 100.

In operation, the feed system 120 delivers material to be ground to the grinding unit 110. The material to be ground is then ground to sufficiently small size in view of the screen sizes and cutters 113 which are mounted onto the drum 114. After passing through the screen, the material is dropped onto the conveyer 130.

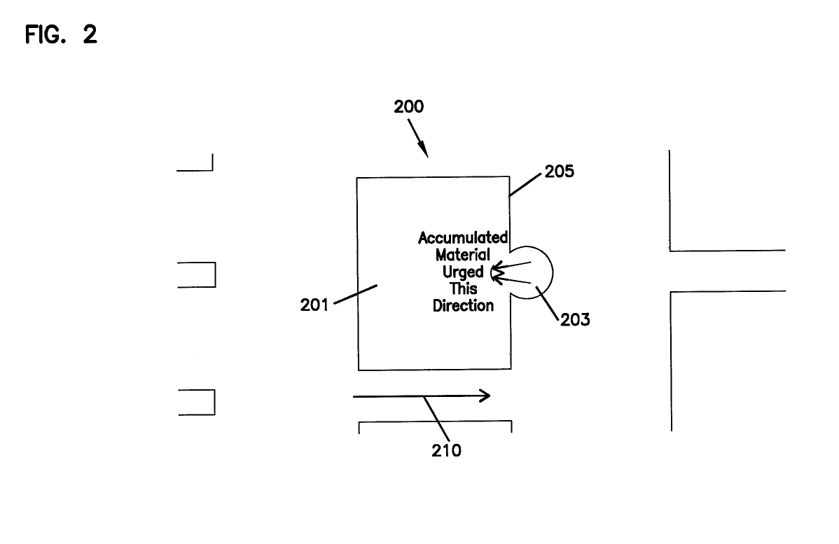

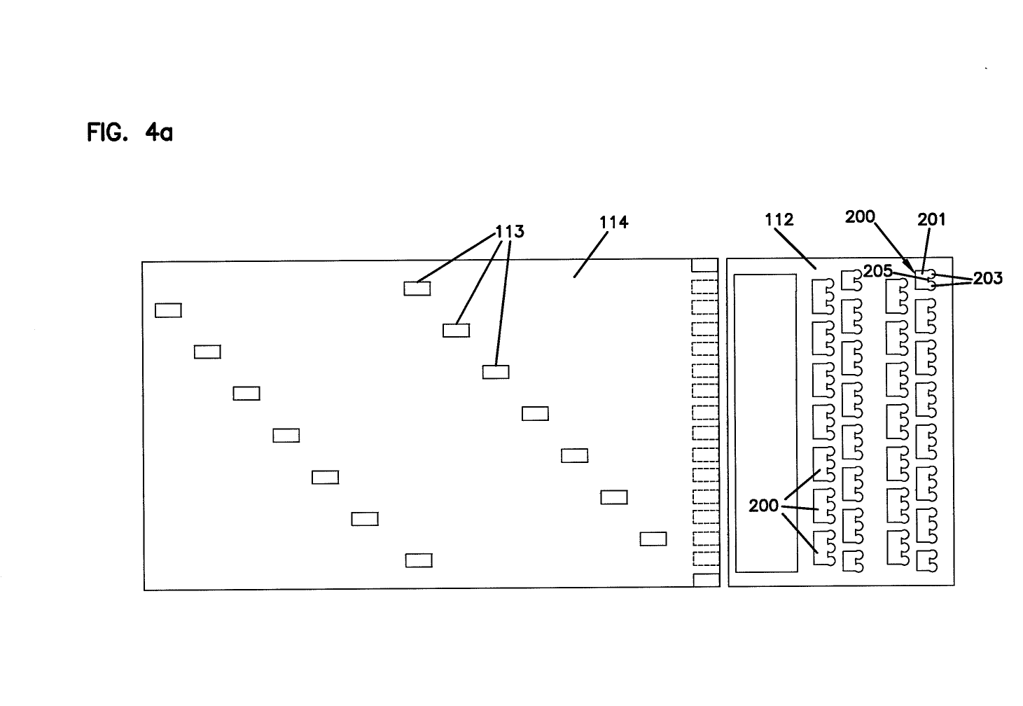

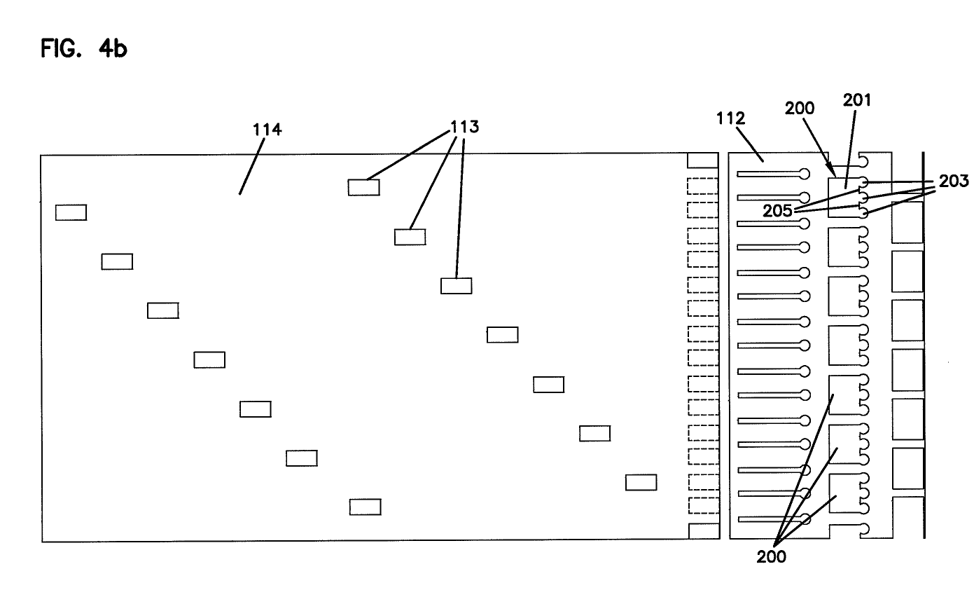

Turning now to FIG. 2, a schematic enlarged illustration of an individual opening 200 in the screen 112 is illustrated. As can be seen, the opening 200 includes a first portion 201 that is formed in the screen. The first portion 201 generally takes the shape of a polygon, preferably a quadrilateral, and more preferably a rectangle. The first portion 201 defines the hole or opening in the screen 112 through which the material passes after being cut by the individual flights of cutters 113. While only one opening is illustrated in FIG. 2, there is generally a plurality of openings in the screen. The exact number and shape of the openings is dependent on the material being ground and the desired end size. This is discussed further below in connection with FIGS. 4a and 4b.

The direction of travel of the drum 114 relative to the opening 200 is shown by the arrow designated 210. The direction of the drum 114 travel has the effect of urging material against the trailing edge 205 of the opening 200 (while the helically arranged cutters 113 may also tend to move the material in the direction of the longitudinal axis of the drum 114—e.g., normal to the direction of the arrow designated 210). Locating the second portion of the opening 203 on or along the trailing edge 205 thereby tends to gather the material in the second portion 203 of the opening 200. In the preferred embodiment, the second portion 203 is arranged and configured to congregate the material such that the material is urged back into the grinding chamber.

More specifically, as the drum 114 rotates, the cutters 113 engage the material. If the material is stringy, it may not move through one of the plurality of openings 200 and/or it may move partially through an opening 200. In either of these events, it may become lodged against a trailing edge 205. Due to the force exerted on the material by the drum 114—either directly or indirectly (e.g., directly by the drum 114 and cutters 113 or indirectly on individual pieces of material from other individual pieces of material in contact with the drum 114 and cutters 113) the material will tend to move against and then along the trailing edge 205 into the second portion 203 of the opening 200. As the material continues to build up in the second portion 203, it is forced around the edge of the second portion 203 and then back into the first portion 201 of the opening.

It will be appreciated that a number of shapes other than circular may be used to form the second portion 203 of the opening. Such shape may include ovals, triangles, and lobed shapes. Any shape which tends to congregate the material into a group and urge the material back into the cutting chamber for engagement with a cutter 113 passing by the opening 200 may be employed. Also, while the connection between the first 201 and second 203 portions is shown as a narrowed area, such connection may be wider.

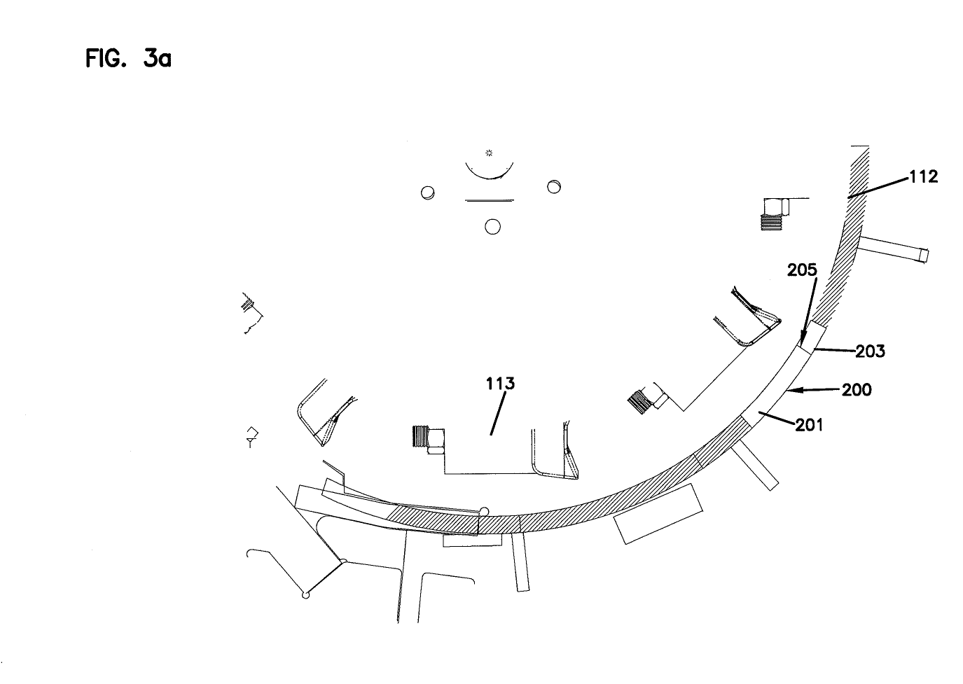

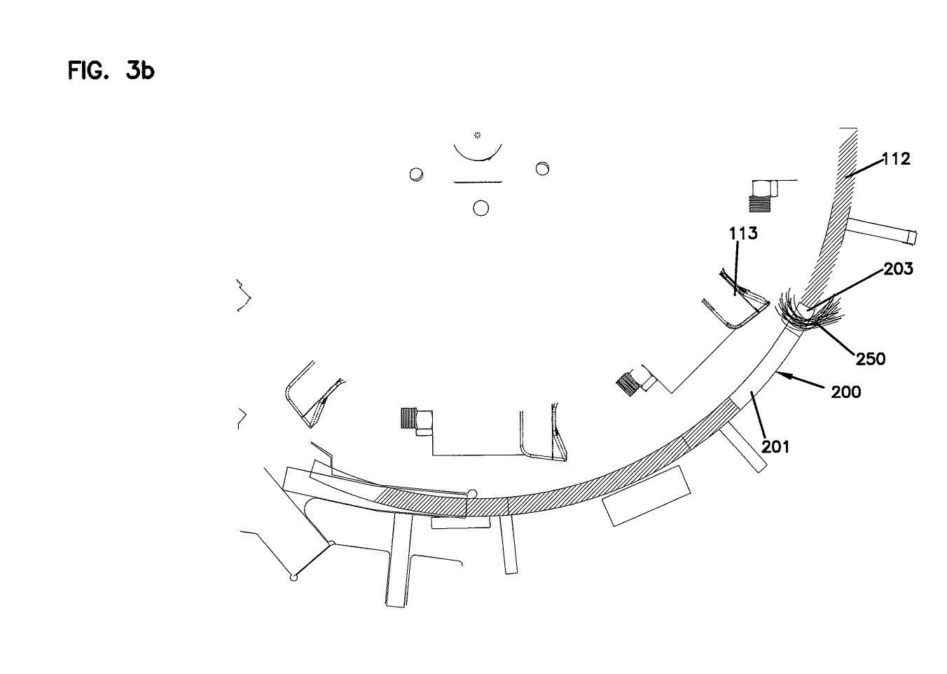

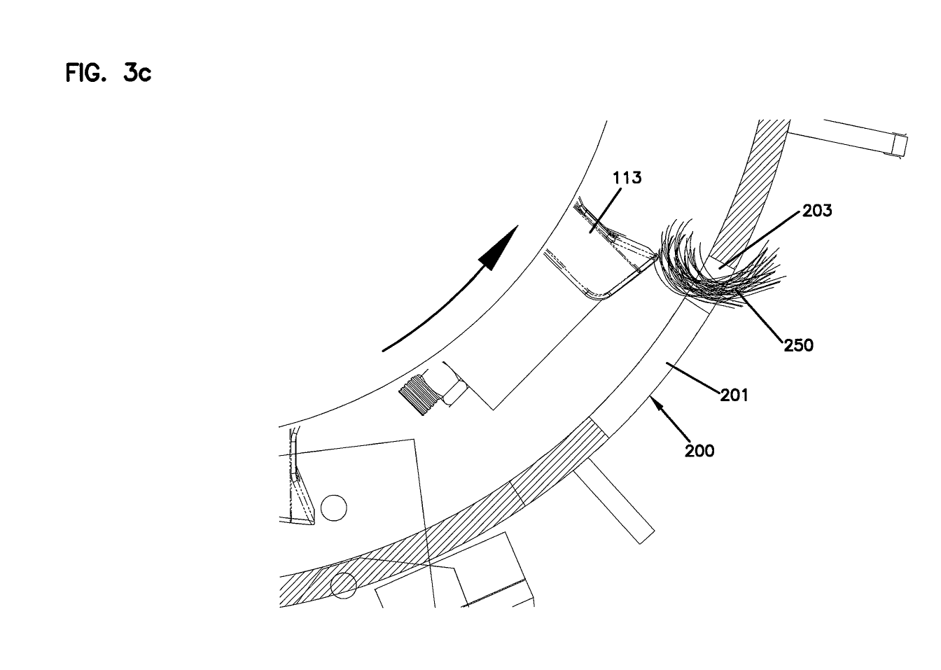

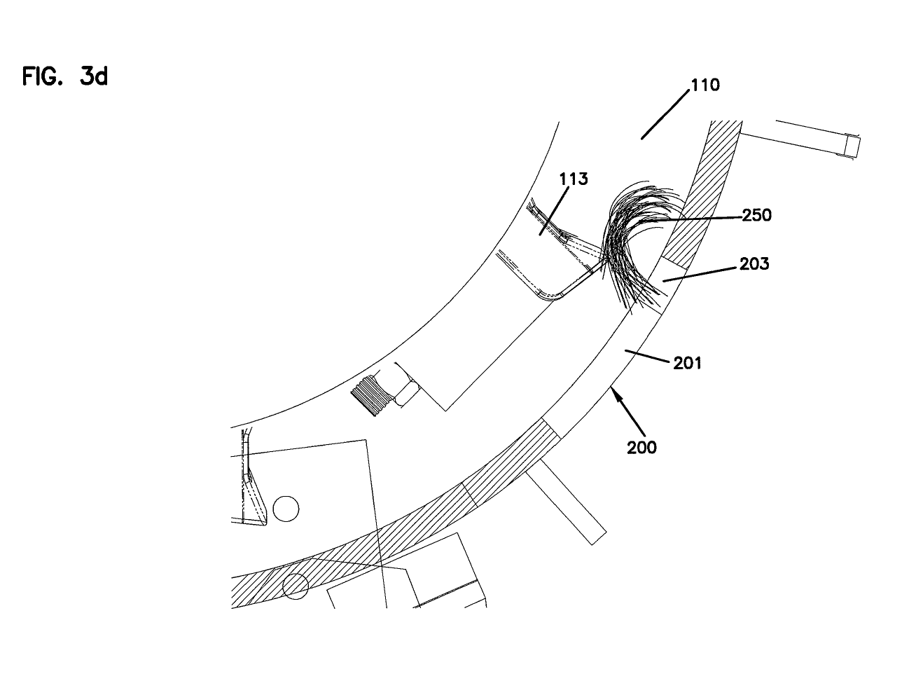

Turning now to FIGS. 3a-3d, the sequence of events in which the material is congregated and focused will be described. First in FIG. 3a, the screen 112 and the cutters 113 are shown in schematic cross section. Trailing edge 205 is illustrated by the line between the first portion 201 and the second portion 203 of opening 200. In FIG. 3b, some material 250 is shown as having been congregated in the second portion 203 of the opening 200. In FIG. 3c, the material 250 has continued to build up and at least some of the material 250 is urged back toward the first portion 201. At FIG. 3d, enough material 250 has accumulated and been urged in a direction toward the cutters 113 such that a passing cutter 113 can engage the material 250, remove it from the second opening 203, and return it into the cutting area 110. Once the material 250 is returned into the cutting area 110, the material can be further reduced until it is of sufficient size to move properly through the first portion 201 of the opening 200.

FIGS. 4a and 4b schematically illustrate the arrangement of the flights of cutters 113 which are located about the periphery of the drum 114. In one embodiment, the arrangement of the cutters 113 forms a generally helical shape about the drum 114. As shown in FIGS. 4a and 4b, the drum 114 is laid out flat—but in operation it will be appreciated that the drum 114 would be generally circular with the cutters 113 arranged about its circumference. The screen 112 is illustrated as including a plurality of openings 200 with each opening 200 having a corresponding first portion 201 and a second portion 203 (only one opening 200 being shown with the designations 201 and 203 for ease of illustration). In this arrangement, the size of the openings 200 may be adjusted based on the material, its desired end size, and its susceptibility of becoming trapped or hung up on the trailing edge 205 of the individual openings 200. It will be appreciated that the second portions 203 of the openings 200 may include multi-lobed arrangements as shown in FIG. 4a and as described above. In another embodiment, screen 112 may be designed such that not all openings 200 include an associated second portion 203.

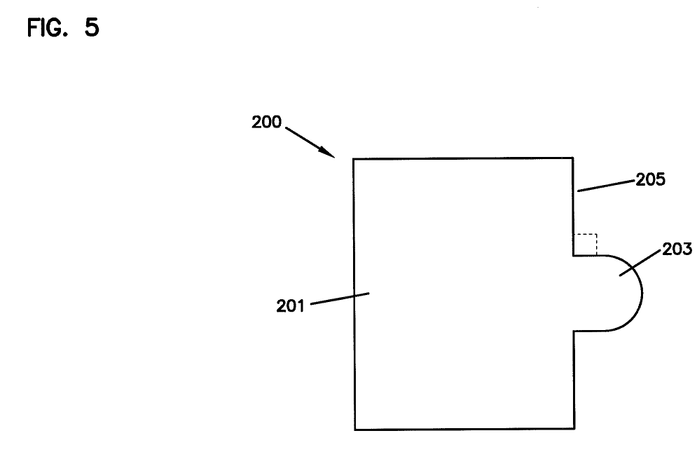

Turning to FIG. 5, an alternative embodiment of the second portion 203 of opening 200 is illustrated. In this embodiment, the tangent from the circular opening 203 joins the trailing edge 205 of the first opening 201 at an approximate right angle. This design may be used so that the second opening 203 does not tend to entrain the material within the second opening 203, but rather the material more easily is congregated for engagement with a cutter 113 which sweeps past the opening 200 as the drum 114 rotates.

While particular embodiments of the invention have been described with respect to its application, it will be understood by those skilled in the art that the invention is not limited by such application or embodiment or the particular components disclosed and described herein. It will be appreciated by those skilled in the art that other components that embody the principles of this invention and other applications therefore other than as described herein can be configured within the spirit and intent of this invention. The arrangement described herein is provided as only one example of an embodiment that incorporates and practices the principles of this invention. Other modifications and alterations are well within the knowledge of those skilled in the art and are to be included within the broad scope of the appended claims.

We claim:

1. A screen apparatus for a grinder comprising:
a) a sheet of material formed about the periphery of a grinding drum having cutters arranged on the periphery, the grinding drum rotating about an axis of rotation; and
b) an opening defined by and formed in the sheet of material, the opening including:
i) a first portion sized and configured to allow ground material to pass therethrough;
ii) a trailing edge; and
iii) a second portion connected to the first portion along the trailing edge, wherein the second portion is arranged and configured to congregate material and urge the material back into the first portion.

2. The screen of claim 1, wherein the second portion is generally circular.

3. The screen of claim 1, wherein the second portion includes lobed shape.

4. The screen of claim 1, wherein the screen includes a plurality of openings with each opening including a corresponding second portion.

5. The screen of claim 1, wherein the grinding device is a horizontal grinder.
